(19) United States
(12) Patent Application Publication
(10) Pub. No.: US 2011/0188581 A1
(43) Pub. Date: Aug. 4, 2011

(54) FILTER AND FILTERING METHOD FOR DEBLOCKING OF INTRA MACROBLOCK

(76) Inventors: Hae-Chul Choi, Daejeon (KR); Se Yoon Jeong, Daejeon (KR); Sung-Chang Lim, Daejeon (KR); Jin Soo Chol, Daejeon (KR); Jin Wod Hong, Daejeon (KR); Dong-Gyu Sim, Seoul (KR); Seoung-Jun Oh, Seoul (KR); Chang-Beom Ahn, Seoul (KR); Gwang Hoon Park, Seoul (KR); Hyun Ho Jo, Seoul (KR); Kwang-Su Jung, Seoul (KR)

(21) Appl. No.: 13/003,677

(22) PCT Filed: Jul. 10, 2009
(86) PCT No.: PCT/KR09/03803

§ 371 Date: Apr. 15, 2011

(30) Foreign Application Priority Data
Jul. 11, 2008 (KR) 10-2008-0067331
Jul. 3, 2009 (KR) 10-20089-0060478

(51) Int. Cl. H04N 7/26

(52) U.S. Cl. 375/240.24; 375/E07.2

(57) ABSTRACT

Provided is a method and apparatus for adaptively performing deblocking filtering using a quantization parameter, based on a video block unit in a boundary between macroblocks including an intra macroblock. The filter and filtering method may enhance a compression rate of a high resolution video and enhance a video compression environment.

### TECHNICAL FIELD

The present invention relates to a method and apparatus that may adaptively perform deblocking filtering for boundaries of intra macroblocks using a quantization parameter to thereby enhance compression performance of high resolution videos.

### BACKGROUND ART

The H.264/Advanced Video Coding (AVC) standard is currently being widely used and it was developed by the Joint Video Team (JVT) organized by the International Telecommunication Union (ITU)-T Video Coding Experts Group (VCEG) and the International Organization for Standardization (ISO)/International Electrotechnical Commission (IEC) Moving Picture Experts Group (MPEG).

The H.264/AVC divides an encoding target video into a plurality of macroblocks to encode each of the macroblock. In this instance, distortion may occur in pixels that are located in outer portion of the macroblocks due to the effect of quantization. In order to remove the distortion, the H.264/AVC may perform deblocking filtering for a block boundary. In the deblocking filter of the H.264/AVC, a boundary strength value is computed in a block boundary, and then, filtering may be conducted for each boundary pixel depending on various conditions.

### DISCLOSURE OF INVENTION

### Technical Goals

An aspect of the present invention is to enhance a video compression efficiency of high resolution and high quality videos.

### Technical Solutions

According to an aspect of the present invention, there is provided a video encoder including: a filtering value generator to generate a filtering value of an outermost pixel that is adjacent to a boundary of an intra macroblock, based on neighboring pixel values of the outermost pixel and a quantization parameter of the intra macroblock; and a deblocking filter to perform deblocking filtering for the outermost pixel based on the filtering value.

According to another aspect of the present invention, there is provided a video decoder including: an offset value extractor to extract an offset value from a slice header of a slice to which macroblocks belong; a threshold calculator to calculate a threshold of the intra macroblock based on the extracted offset value; a filtering value calculator to calculate a filtering value of an outermost pixel that is adjacent to a boundary of the intra macroblock, based on the threshold; and a deblocking filter to perform deblocking filtering for the outermost pixel, based on the filtering value.

According to still another aspect of the present invention, there is provided a video decoder including: a threshold calculator to calculate a threshold with respect to an intra macroblock based on an offset value that is extracted from a slice header of a slice to which macroblocks belong; a filtering value generator to generate a filtering value of an outermost pixel adjacent to a boundary of the intra macroblock, based on a neighboring pixel value of the outermost pixel; a filtering value updating unit to compare the filtering value with the threshold, and to update the filtering value; and a deblocking filter to perform deblocking filtering for the outermost pixel based on the updated filtering value.

### Advantageous Effect

According to embodiments of the present invention, it is possible to enhance a video compression efficiency of high resolution and high quality videos.

### BRIEF DESCRIPTION OF DRAWINGS

FIG. 1 is a diagram illustrating an example of performing deblocking filtering for outermost pixels adjacent to a boundary of an intra macroblock according to an embodiment of the present invention;

FIG. 2 is a diagram illustrating pixels adjacent to a boundary of a macroblock according to an embodiment of the present invention;

FIG. 3 is a flowchart illustrating an operation of determining whether to apply filtering of pixels adjacent to a boundary of a macroblock according to an embodiment of the present invention;

FIG. 4 is a flowchart illustrating an operation of performing, by a video encoder, deblocking filtering for pixels adjacent to a boundary of an intra macroblock according to an embodiment of the present invention;

FIG. 5 is a diagram illustrating an example of a slice header storing an offset to determine a threshold according to an embodiment of the present invention;

FIG. 6 is a block diagram illustrating a structure of a video encoder according to an embodiment of the present invention;

FIG. 7 is a block diagram illustrating a structure of a video decoder according to an embodiment of the present invention; and

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

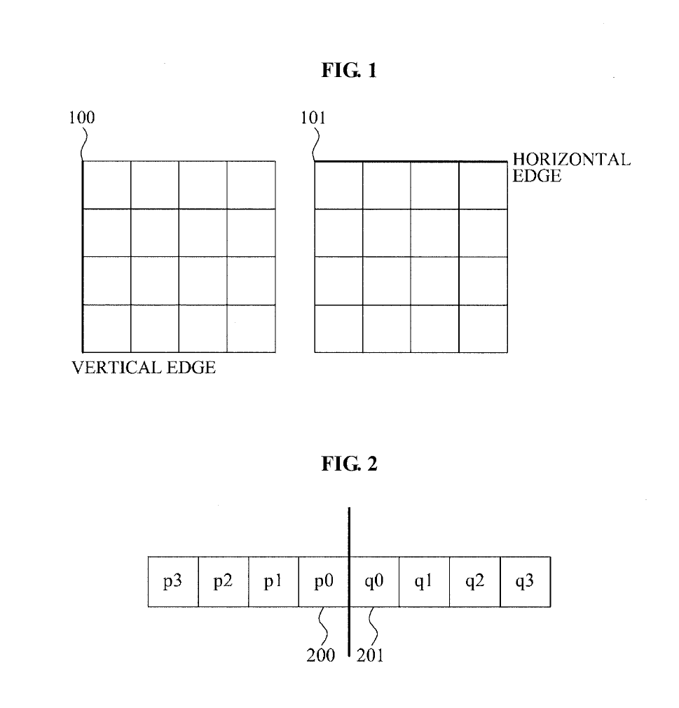

FIG. 1 is a diagram illustrating an example of performing deblocking filtering for outermost pixels adjacent to a boundary of an intra macroblock according to an embodiment of the present invention.

According to an embodiment of the present invention, the video encoder may perform deblocking filtering for pixels that are located in a boundary of each of macroblocks to thereby remove distortion between the macroblocks and to provide a more natural video.

Referring to FIG. 1, deblocking filtering may be performed across a vertical edge 100 or a horizontal edge 101 of each of macroblocks.

According to an embodiment of the present invention, when at least one of a first macroblock and a second macroblock adjacent to a left of the first macroblock corresponds to an intra macroblock, deblocking filtering may be performed for pixels that are located in a boundary between the first macroblock and the second macroblock.

Also, according to an embodiment of the present invention, when at least one of a first macroblock and a second macroblock adjacent to an upper portion of the first macroblock corresponds to an intra macroblock, deblocking filtering may be performed for pixels that are located in a boundary between the first macroblock and the second macroblock.

FIG. 2 is a diagram illustrating pixels p0, p1, p2, p3, q0, q1, q2, and q3 adjacent to a boundary between two macroblocks according to an embodiment of the present invention.

The pixels p0, p1, p2, and p3 may correspond to pixel values of the macroblock that is located on a left-hand side based on the boundary between the two macroblocks. The pixels q0, q1, q2, and q3 correspond to pixel values of the macroblock that is located on a right-hand side based on the boundary between the two adjacent macroblocks.

Although the plurality of macroblocks is horizontally arranged in FIG. 2, the present invention is not limited thereto. Specifically, the plurality of macroblocks may be vertically arranged. In this case, the pixels p0, p1, p2, and p3 correspond to pixel values of macroblocks that are located on an upper portion based on the boundary between the macroblocks. The pixels q0, q1, q2, and q3 correspond to pixel values of macroblocks that are located on a lower portion based on the boundary between the macroblocks.

According to an embodiment of the present invention, among the pixels p0, p1, p2, p3, q0, q1, q2, and q3 that are located around the boundary between the macroblocks, the video encoder may perform deblocking filtering for the pixels p0 and q0 that are adjacent to the boundary between the macroblocks, and may not perform deblocking filtering for the pixels p1, p2, p3, q1, q2, and q3 that are not adjacent to the boundary between the macroblocks.

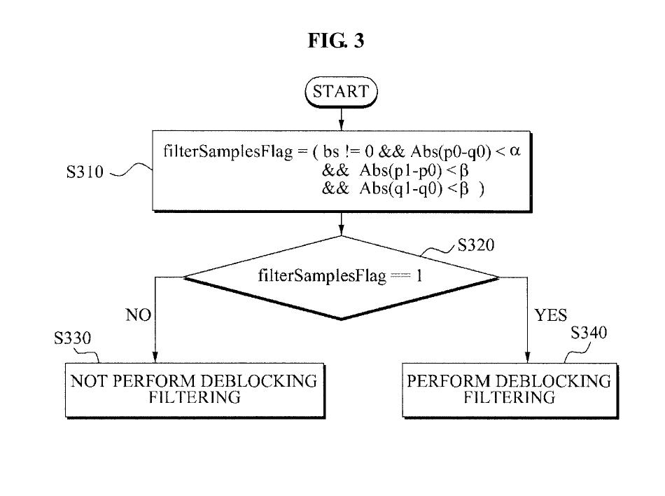

FIG. 3 is a flowchart illustrating an operation of determining whether to apply filtering of pixels located around a boundary of a macroblock according to an embodiment of the present invention.

In operation S310, both video encoder and decoder according to an embodiment of the present invention may calculate a parameter ‘filterSamplesFlag’ to determine whether to perform deblocking filtering. According to an embodiment of the present invention, the video encoder and decoder may calculate ‘filterSamplesFlag’ based on a boundary strength (BS) that is set for each of the macroblocks, and a pixel value of each of pixels p0, p1, q0, and q1 that are adjacent to the boundary between the macroblocks.

Referring to FIG. 3, when a value of the boundary strength is set to ‘0’, the video encoder and decoder may determine a value of ‘filterSamplesFlag’ as zero.

When a difference between the pixel values of the pixels p0, p1, q0, and q1 adjacent to the boundary between the macroblocks is greater than a predetermined threshold α or β, the video encoder and decoder may determine the value of ‘filterSamplesFlag’ as zero. Specifically, when the pixel value difference is greater than the predetermined threshold, the video encoder and decoder may determine a corresponding boundary as a substantial boundary portion of video to thereby not perform deblocking filtering for the boundary.

In operation S320, the video encoder and decoder may determine whether the value of ‘filterSamplesFlag’ is equal to ‘1’.

When the value of ‘filterSamplesFlag’ is not equal to ‘1’, the video encoder and decoder may not perform deblocking filtering for the intra macroblock in operation S330.

Conversely, when the value of ‘filterSamplesFlag’ is equal to ‘1’, the video encoder and decoder may perform deblocking filtering for the intra macroblock.

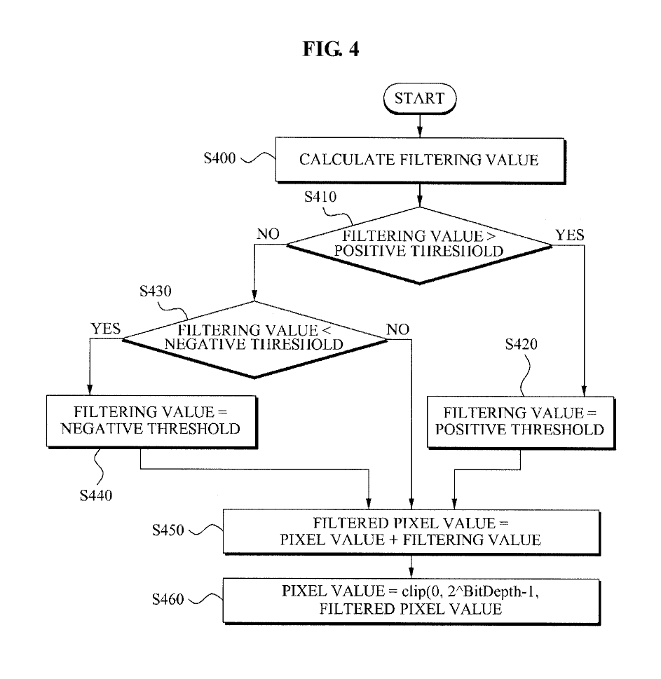

Hereinafter, it is assumed that the video encoder and decoder perform deblocking filtering for the intra macroblock, which will be described in detail with reference to FIG. 4.

FIG. 4 is a flowchart illustrating an operation of performing, by a video encoder and decoder, deblocking filtering for pixels adjacent to a boundary of an intra macroblock according to an embodiment of the present invention.

In operation S400, the video encoder and decoder may calculate a filtering value of a deblocking target pixel. The video encoder and decoder may select, as the deblocking target pixel, an outermost pixel of the intra macroblock. According to an embodiment of the present invention, the video encoder and decoder may calculate the filtering value using pixel values of other pixels adjacent to the deblocking target pixel.

In operation S410, the video encoder and decoder may compare the filtering value of the deblocking target pixel with a positive threshold.

When the filtering value of the deblocking target pixel is less than the positive threshold, the video encoder and decoder may compare the filtering value of the deblocking target pixel with a negative threshold in operation S430.

When the filtering value of the deblocking target pixel is less than the negative threshold in operation S430, the video encoder and decoder may determine the negative threshold as the filtering value in operation S440.

Conversely, when the filtering value of the deblocking target pixel is greater than the positive threshold, the video encoder and decoder may determine the positive threshold as the filtering value in operation S420.

In operation S450, the video encoder and decoder may perform deblocking filtering for the deblocking target pixel based on the filtering value. According to an embodiment of the present invention, the video encoder and decoder may perform deblocking filtering by adding up a pixel value of the deblocking target pixel and the filtering value.

In operation S460, the video encoder and decoder may limit a pixel value of a deblocking filtered pixel to be within a predetermined range. According to an embodiment of the present invention, when a pixel value of a deblocking filtered pixel is less than a predetermined minimum value, the video encoder and decoder may determine the minimum value as the pixel value of the deblocking filtered pixel. When the pixel value of the deblocking filtered pixel is greater than a predetermined maximum value, the video encoder and decoder may determine the maximum value as the pixel value of the deblocking filtered pixel.

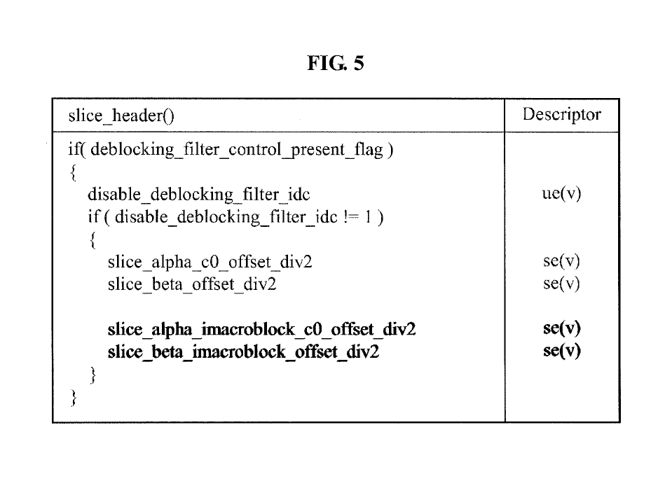

FIG. 5 is a diagram illustrating an example of a slice header storing an offset to determine a threshold according to an embodiment of the present invention. According to an embodiment of the present invention, a video encoder may perform deblocking filtering using a positive threshold and a negative threshold. The video encoder may store, in a slice header of a slice to which macroblocks belong, an offset value that is used to calculate the positive threshold and the negative threshold.

The video decoder may calculate the positive threshold or the negative threshold with respect to an intra macroblock, based on the stored offset value. The video decoder may perform deblocking filtering for a video that is restored based on a macroblock unit, using the positive threshold or the negative threshold.

The video decoder may determine whether to perform deblocking filtering for a macroblock, based on a value of a parameter ‘deblocking_filter_control_present_flag’ and a value of a parameter ‘disable_deblocking_filter_idc’ that is included in the slice header of a slice to which macroblocks belong.

According to an embodiment of the present invention, when it is determined to perform deblocking filtering for a macroblock, the video decoder may calculate a threshold with respect to the macroblock based on an offset value ‘slice_alpha_c0_offset_div2’ and an offset value ‘slice_beta_offset_div2’ that are stored in a slice header.

According to an embodiment of the present invention, the video decoder may use, with respect to an intra macroblock, the same threshold as a threshold with respect to an inter macroblock.

According to an embodiment of the present invention, the video decoder may use, with respect to an intra macroblock, a different threshold from a threshold with respect to an inter macroblock. Specifically, the video decoder may calculate the threshold with respect to the intra macroblock that is different from the threshold with respect to the inter macroblock, based on an offset value ‘slice_alpha_imacroblock_c0_offset_div2’ and an offset value ‘slice_beta_imacroblock_offset_div2’.

Also, according to an embodiment of the present invention, the video encoder may store, in a slice header, an offset value to calculate a threshold with respect to an intra macroblock. Referring to FIG. 5, an offset value ‘slice_alpha_imacroblock_c0_offset_div2’ and an offset value ‘slice_beta_imacroblock_offset_div2’ may be used to calculate the threshold with respect to the intra macroblock.

The video decoder may calculate the threshold that may be applied only to the intra macroblock, using the offset value ‘slice_alpha_imacroblock_c0_offset_div2’ and the offset value ‘slice_beta_imacroblock_offset_div2’.

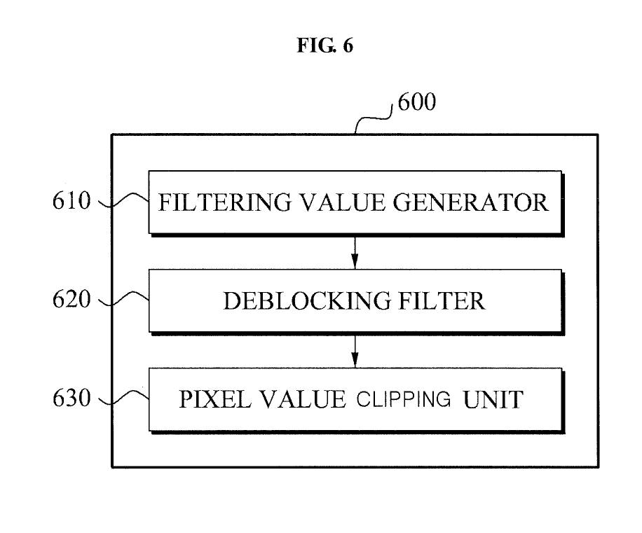

FIG. 6 is a block diagram illustrating a structure of a video encoder 600 according to an embodiment of the present invention. The video encoder 600 may include a filtering value generator 610, a deblocking filter 620, and a pixel value clipping unit 630.

The filtering value generator 610 may generate a filtering value of an outermost pixel that is adjacent to a boundary of an intra macroblock. According to an embodiment of the present invention, the filtering value generator 610 may generate the filtering value based on a neighboring pixel value of the outermost pixel or a quantization parameter of the intra macroblock.

According to an embodiment of the present invention, the filtering value generator 610 may limit the generated filtering value of the outermost pixel to be within a predetermined range. For this, the filtering value generator 610 may compare the generated filtering value with a positive threshold and a negative threshold. Hereinafter, it is assumed that the positive threshold is greater than the negative threshold.

The filtering value generator 610 may compare the generated filtering value with a positive threshold. When the filtering value is greater than the positive threshold, the filtering value generator 610 may determine the positive threshold as the filtering value.

Conversely, when the filtered value is less than the positive threshold, the filtering value generator 610 may compare the generated filtering value with a negative threshold. When the filtering value is less than the negative threshold, the filtering value generator 610 may determine the negative threshold as the filtering value.

Specifically, the filtering value may be determined as the positive threshold, the negative threshold, or a value between the positive threshold and the negative threshold.

The deblocking filter 620 may perform deblocking filtering for the outermost pixel based on the generated filtering value. According to an embodiment of the present invention, the deblocking filter 620 may perform deblocking filtering by adding up a pixel value of the outermost pixel and the filtering value.

The pixel value clipping unit 630 may limit a pixel value of the deblocking filtered outermost pixel to be within a predetermined range. According to an embodiment of the present invention, the pixel value clipping unit 630 may compare the pixel value of the deblocking filtered outermost pixel with a maximum value and a minimum value.

When the pixel value of the outermost pixel is greater than the maximum value, the pixel value clipping unit 630 may determine the maximum value as the pixel value of the outermost pixel.

Conversely, when the pixel value of the outermost pixel is less than the minimum value, the pixel value clipping unit 630 may determine the minimum value as the pixel value of the outermost pixel.

According to an embodiment of the present invention, the pixel value clipping unit 630 may limit the pixel value of the outermost pixel according to a bit depth.

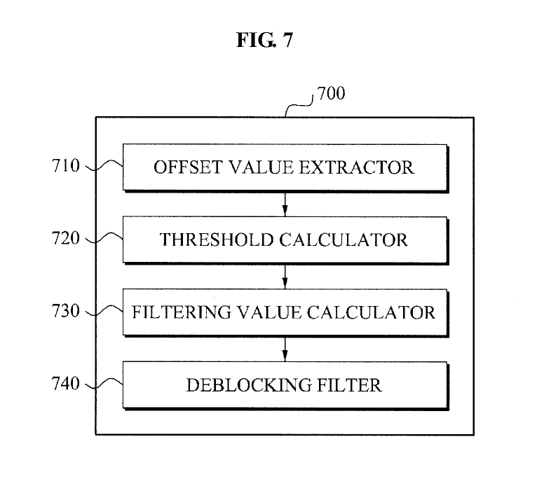

FIG. 7 is a block diagram illustrating a structure of a video decoder 700 according to an embodiment of the present invention. The video decoder 700 may include an offset value extractor 710, a threshold calculator 720, a filtering value calculator 730, and a deblocking filter 740.

The offset value extractor 710 may extract an offset value from a slice header of a slice to which macroblocks belong. As shown in FIG. 5, the slice header may include at least one offset value.

The threshold calculator 720 may calculate a threshold with respect to the intra macroblock based on the extracted offset value. According to an embodiment of the present invention, the threshold calculator 720 may calculate a positive threshold and a negative threshold based on the extracted offset value.

The filtering value calculator 730 may calculate a filtering value of an outermost pixel that is adjacent to a boundary of the intra macroblock, based on the calculated threshold. According to an embodiment of the present invention, the filtering value calculator 730 may generate the filtering value of the outermost pixel and compare the filtering value with the threshold to thereby determine the filtering value of the outermost pixel.

According to an embodiment of the present invention, when the filtering value is greater than the positive threshold, the filtering value calculator 730 may determine the positive threshold as the filtering value.

When the filtering value is less than the negative threshold, the filtering value calculator 730 may determine the negative threshold as the filtering value.

According to an embodiment of the present invention, when the generated filtering value of the outermost pixel is a value between the negative threshold and the positive threshold, the filtering value calculator 730 may determine the generated filtering value as a final filtering value.

The deblocking filter 740 may perform deblocking filtering for the outermost pixel based on the calculated filtering value. According to an embodiment of the present invention, the deblocking filter 740 may perform deblocking filtering by adding up a pixel value of the outermost value and the filtering value.

According to an embodiment of the present invention, the video decoder 700 may further include a pixel value clipping unit (not shown) to limit the pixel value of the deblocking filtered outermost pixel to be within a predetermined range.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A video encoder comprising:
a filtering value generator to generate a filtering value of pixels that are adjacent to a boundary of an intra macroblock, based on a neighboring pixel value of the outermost pixel and quantization parameters of macroblocks located in adjacent to a filtering boundary; and
a deblocking filter to perform deblocking filtering for the pixels that are adjacent to a boundary of an intra macroblock based on the filtering value.

2. The video encoder of claim 1, wherein:
the filtering value generator includes a threshold calculator to calculate a threshold with respect to the intra macroblock based on the best offset in the slice.

3. The video encoder of claim 1, wherein:
the filtering value generator compares the generated filtering value with a positive threshold, and
when the filtering value is greater than the positive threshold, the filtering value generator determines the positive threshold as the filtering value.

4. The video encoder of claim 1, wherein:
the filtering value generator compares the generated filtering value with a negative threshold, and
when the filtering value is less than the negative threshold, the filtering value generator determines the negative threshold as the filtering value.

5. The video encoder of claim 1, wherein the deblocking filter performs deblocking filtering by adding up a pixel value of pixels and the filtering value.

6. The video encoder of claim 1, further comprising:
a pixel value clipping unit to limit a pixel value of the deblocking filtered pixels to be within a predetermined range.

7. The video encoder of claim 5, wherein the pixel value clipping unit limits the pixel value of the deblocking filtered pixels to be within the range from a minimum value to a maximum value based on a bit depth.

8. A video decoder comprising:
an offset value extractor to extract an offset value from a slice header of a slice to which macroblocks belong;
a threshold calculator to calculate a threshold with respect to the intra macroblock based on the extracted offset value;
a filtering value calculator to calculate a filtering value of pixels that is adjacent to a boundary of the intra macroblock, based on the threshold; and
a deblocking filter to perform deblocking filtering for the pixels, based on the filtering value.

9. The video decoder of claim 8, wherein:
the threshold calculator generates a positive threshold based on the extracted offset value, and
when the filtering value of pixels is greater than the positive threshold, the filtering value calculator determines the positive threshold as the filtering value.

10. The video decoder of claim 8, wherein:
the threshold calculator generates a negative threshold, based on the extracted offset value, and
when the filtering value of pixels is less than the negative threshold, the filtering value calculator determines the negative threshold as the filtering value.

11. The video decoder of claim 8, wherein the deblocking filter performs deblocking filtering by adding up a pixel value of pixels and the filtering value.
